(19) United States
(12) Patent Application Publication
(10) Pub. No.: US 2019/0180249 A1
(43) Pub. Date: Jun. 13, 2019

(54) AUTOMATED APPOINTMENT SCHEDULING USING TEXT-BASED CHARACTER

(71) Applicant: TimeTrade Systems, Inc., Tewksbury, MA (US)

(72) Inventors: Steven Connolly, Tewksbury, MA (US); Chris Gilmore, Tewksbury, MA (US)

(21) Appl. No.: 16/184,256

(22) Filed: Nov. 8, 2018

Related U.S. Application Data
(60) Provisional application No. 62/597,694, filed on Dec. 12, 2017.

(51) Int. Cl. G06Q 10/10; H04L 12/58; H04L 29/08; G06F 17/27

(52) U.S. Cl. CPC G06Q 10/1095; H04L 51/046; H04L 51/36; G06F 17/2705; H04L 67/32

(57) ABSTRACT

In one example embodiment, a server parses a text-based communication for a particular text-based character. The server identifies, in the text-based communication, the particular text-based character and a sequence of text-based characters associated with the particular text-based character. Based on a mapping of the sequence of text-based characters to a particular meeting type, the server determines that the sequence of text-based characters corresponds to the particular meeting type. The server generates a meeting template of the particular meeting type.

### CROSS REFERENCE TO RELATED APPLICATION

This application claims priority to U.S. Provisional Application No. 62/597,694, filed Dec. 12, 2017, the entirety of which is incorporated herein by reference.

### TECHNICAL FIELD

The present disclosure relates to appointment scheduling.

### BACKGROUND

Professionals throughout various industries often spend excess time and resources manually organizing meetings with colleagues and/or customers via standard communication channels such as email, text, within a Customer Relationship Management (CRM) application, social media, etc. This is inefficient and negatively impacts productivity.

### BRIEF DESCRIPTION OF THE DRAWINGS

FIG. 1 illustrates a system for automatically scheduling meetings based on a text-based character, according to an example embodiment.

FIG. 2 illustrates a meeting template produced by a text-based character parsing server, according to an example embodiment.

FIG. 3 illustrates a block diagram of a text-based character parsing server, according to an example embodiment.

FIG. 4 is a flowchart of a method for text-based automated appointment scheduling, according to an example embodiment.

### DESCRIPTION OF EXAMPLE EMBODIMENTS

### Overview

In one example embodiment, a server parses a text-based communication for a particular text-based character. The server identifies, in the text-based communication, the particular text-based character and a sequence of text-based characters associated with the particular text-based character. Based on a mapping of the sequence of text-based characters to a particular meeting type, the server determines that the sequence of text-based characters corresponds to the particular meeting type. The server generates a meeting template of the particular meeting type.

### Example Embodiments

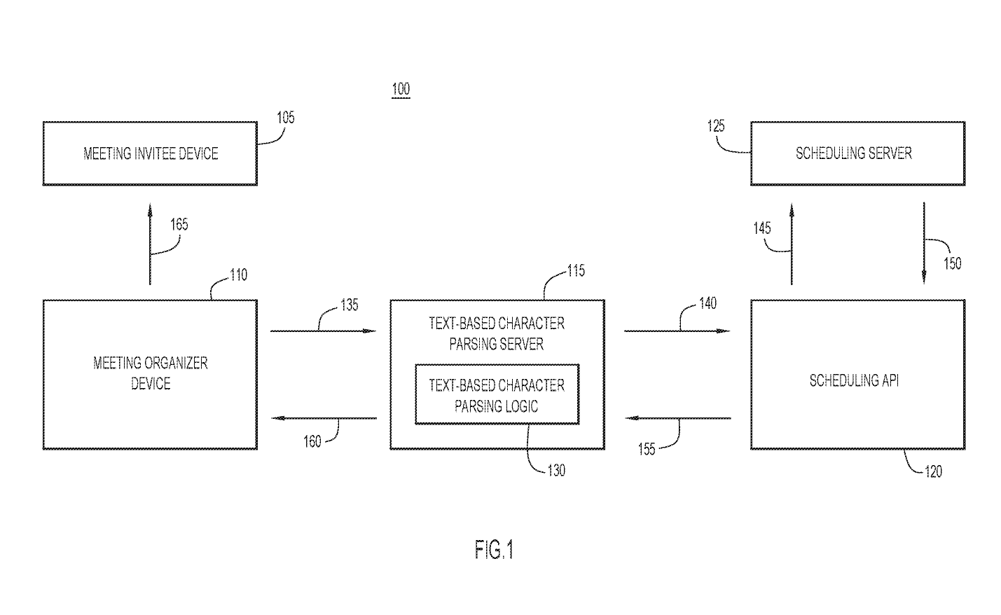

FIG. 1 illustrates system 100 configured for automatically scheduling meetings based on a text-based character. System 100 includes meeting invitee device 105, meeting organizer device 110, text-based character parsing server 115, scheduling Application Programming Interface (API) 120, and scheduling server 125. In one example use case, meeting invitee device 105 is operated by a prospective customer, and meeting organizer device 110 is operated by a sales representative. Meeting organizer device 110 runs a Customer Relationship Management (CRM) application into which the sales representative can log notes from a recent meeting with the prospective customer.

The sales representative determines that the next step with regard to the prospective customer is to schedule a follow-up call. Accordingly, the sales representative types “Had intro call with Prospective Customer, and he was very interested in our offering. Need to #ScheduleFollowupCall” in the notes. Conventionally, the sales representative would need to manually schedule a follow-up call, including, e.g., creating the meeting, calling the customer to determine available times, sending out the invitation, etc. This manual process wastes valuable computing resources (e.g., memory, processors, bandwidth, etc.).

Accordingly, text-based character parsing logic 130 is provided to improve the functioning of computer networks and network devices that utilize such computing resources by providing an efficient alternative to manually scheduling an appointment. Briefly, in this example, text-based character parsing server 115 parses the sales representative's notes (or other text-based user interface) to generate a meeting link associated with the sales representative to automatically schedule a follow-up call with the prospective customer. System 100 may automatically perform the scheduling function on behalf of the sales representative, thereby avoiding manual scheduling of the appointment.

At 135, meeting organizer device 110 sends the notes to text-based character parsing server 115. Text-based character parsing server 115 parses the text-based communication (here, the notes) to determine presence of a particular text-based character (here, a hashtag/pound (i.e., “#”) symbol). Text-based character parsing server 115 identifies, in the notes, the hashtag and a sequence of text-based characters associated with the hashtag. In this example, the sequence of text-based characters is an unbroken sequence of text-based characters following the hashtag (i.e., “ScheduleFollowupCall”). In a further example, text-based character parsing server 115 may identify other information about the meeting from the text. For instance, text-based character parsing server 115 may identify specific meeting attendees from pronouns in the text (e.g., “you” may indicate a meeting invitee, “I” or “me” may indicate a meeting organizer, etc.).

Based on a mapping of “ScheduleFollowupCall” to a particular meeting type (e.g., a follow-up call), text-based character parsing server 115 may determine that “ScheduleFollowupCall” corresponds to a follow-up call. The mapping may include one or more sequences of text-based characters that may be utilized for various meeting templates (e.g., “ScheduleFollowUpCall,” “ScheduleDemo,” “ScheduleServiceVisit,” “ScheduleInstallation,” “ScheduleSupportCall,” etc.). In one example, there is a one-to-one correspondence between sequences of text-based characters and meeting types. For instance, “ScheduleFollowUpCall” may correspond to a follow-up call; “ScheduleDemo” may correspond to meeting involving a product demonstration; “ScheduleServiceVisit” may correspond to a service visit; etc. Text-based character parsing server 115 may thereby extract meeting criteria from saved hashtag templates.

Text-based character parsing server 115 sends, to scheduling server 125, a request to generate an appointment link that identifies a meeting template for a follow-up call. In particular, at 140, text-based character parsing server 115 makes an API call to scheduling API 120 to cause scheduling server 125 to generate the appointment link. At 145, scheduling API 120 sends a request to scheduling server 125 to generate the appointment link. Upon receiving the request, scheduling server 125 generates the appointment link. Scheduling server 125 may generate the appointment link based on the type of meeting and meeting criteria, invitees/participants, availability of the invitees, etc.

At 150, text-based character parsing server 115 sends the appointment link to the scheduling API 120. At 155, text-based character parsing server 115 receives the appointment link from scheduling server 125 (via scheduling API 120). Based on the appointment link, text-based character parsing server 115 generates a meeting template of the particular meeting type (here, a follow-up call). Thus, the appointment link may serve as an access point to the meeting template, and may point to a meeting stored in a database managed by scheduling server 125.

The appointment link may include scheduling information for the sales representative and the prospective customer. The appointment link may further include an identifier of the meeting template, and may also include parameters to customize the meeting template for use as the meeting invitation. For instance, a contact identifier may be appended to the appointment link to populate the contact data of the meeting template. In this example, text-based character parsing server 115 may automatically populate contact data of the meeting template based on the appended contact identifier.

At 160, text-based character parsing server 115 sends the meeting template to meeting organizer device 110. At 165, meeting organizer device 110 sends a meeting invitation based on the meeting template to meeting invitee device 105. Meeting organizer device 110 may send the meeting invitation at the instruction of the sales representative. The prospective customer may have the option to accept, decline, or reschedule the meeting invitation after it is received at meeting invitee device 105.

Because the meeting invitation is automatically customized by text-based character parsing server 115, much of the manual labor involved in scheduling a meeting is eliminated. This mechanism is particularly effective at conserving computing resources when employed at larger scales. It will be appreciated that operations performed by text-based character parsing server 115 and scheduling server 125 may be performed by any number of servers (e.g., a single server or more than two servers). Moreover, meeting invitations may be sent to any number of meeting invitee devices corresponding to one or more meeting invitees.

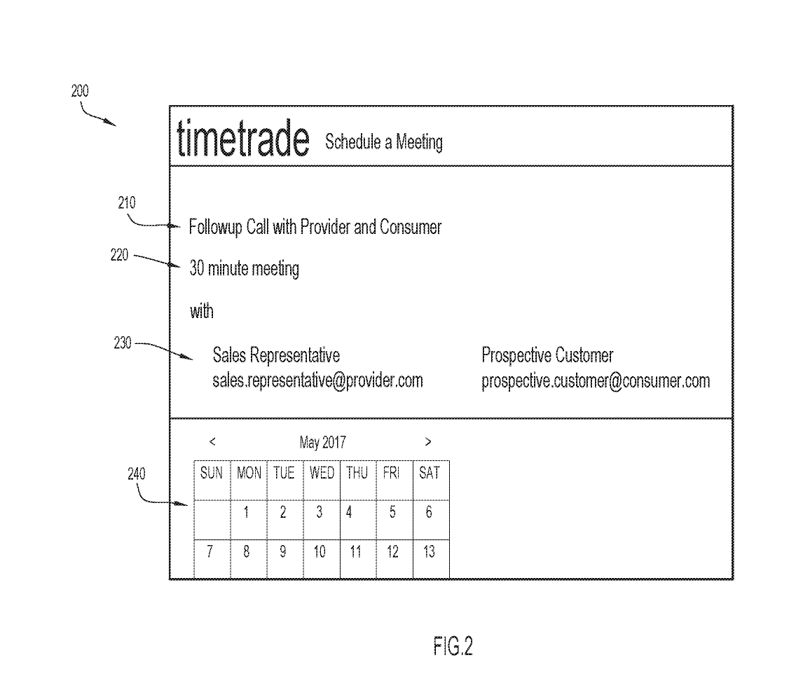

FIG. 2 illustrates meeting template 200 generated by text-based character parsing server 115 in the example of FIG. 1. As shown, meeting template 200 includes title 210, meeting duration indication 220, meeting participant indication 230, and calendar 240. Title 210, “Followup Call with Provider and Consumer,” is based on text-based character parsing server 115 having successfully parsed “#ScheduleFollowupCall.” Meeting duration indication 220, thirty minutes, may be set as a default/standard time for follow-up calls. Meeting participant indication 230 indicates that the sales representative (an employee of Provider) and the prospective customer (an employee of Consumer) are to participate in the meeting. Calendar 240 permits the meeting organizer (here, the sales representative) to select a date and time at which both meeting participants are available. Text-based character parsing server 115 may also auto-populate other fields in the meeting template such as location (e.g., in-person, telephonic, virtual service, etc.), message (e.g., purpose of meeting, custom instructions, etc.), etc.

Techniques for automatically scheduling meetings/appointments using text-based characters (e.g., hashtags) may apply to a variety of use cases in addition to the scenario described above with respect to FIGS. 1 and 2. For instance, another use case may involve online media (e.g., social network, short message service (SMS), etc.). In one example, a user may be interacting with a friend on a social network. By sending the person a message or post containing a hashtag (e.g., “#ScheduleHangOut”), the system may intelligently and automatically attempt to connect all relevant people for a templated type of interaction (e.g., by determining availability, location, and other meeting criteria). Once accepted through some type of acceptance criteria, all parties may be informed of the final scheduled event on their calendars.

Still another use case involves e-mail messages (e.g., threads, chains, etc.). For example, if a user sends an e-mail to a colleague with a hashtag (e.g., “#ScheduleMeeting”) in the e-mail body, the system may automatically create the meeting template with all attendees on the e-mail thread, and automatically place the scheduling link in the e-mail thread for the recipient.

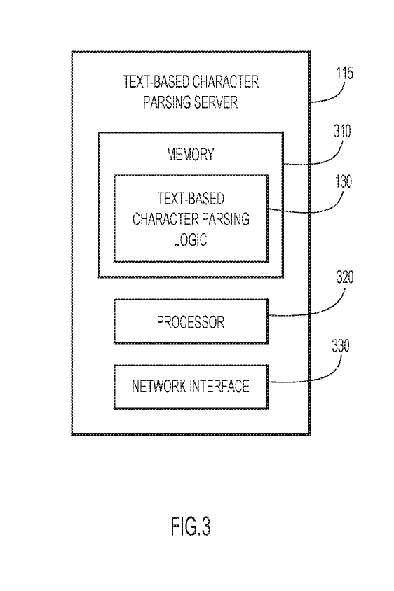

FIG. 3 illustrates a simplified block diagram of text-based character parsing server 115. In this example, text-based character parsing server 115 includes memory 310 that stores instructions for text-based character parsing logic 130, one or more processors 320, and network interface 330. The one or more processors 320 are configured to execute instructions stored in the memory 310 for text-based character parsing logic 130. When executed by the one or more processors 320, text-based character parsing logic 130 causes text-based character parsing server 115 to perform operations described herein. Network interface 330 is a network interface card (or multiple instances of such a device) or other network interface device that enables network communications on behalf of text-based character parsing server 115 for sending and receiving messages.

Memory 310 may be read only memory (ROM), random access memory (RAM), magnetic disk storage media devices, optical storage media devices, flash memory devices, electrical, optical, or other physical/tangible memory storage devices. Thus, in general, memory 310 may be one or more tangible (non-transitory) computer readable storage media (e.g., a memory device) encoded with software comprising computer executable instructions and when the software is executed (by processor 320) it is operable to perform the operations described herein.

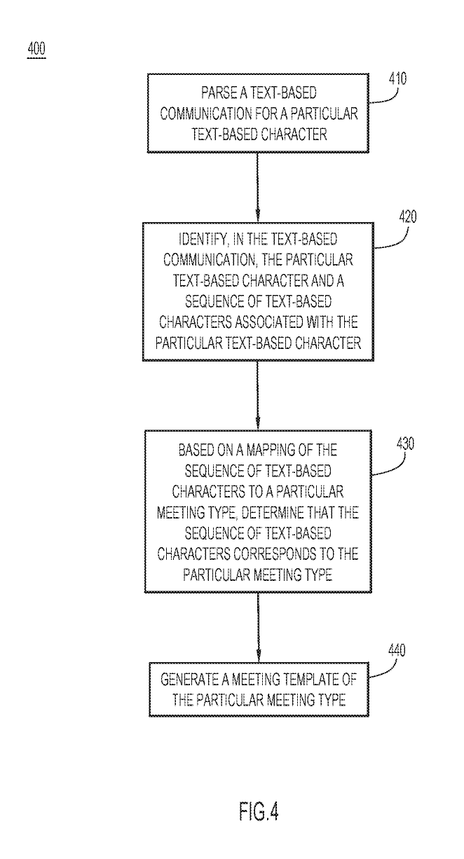

FIG. 4 is a flowchart of a method 400 for text-based automated appointment scheduling. Method 400 may be performed by a server (e.g., text-based character parsing server 115). At 410, the server parses a text-based communication for a particular text-based character. The parsing operation thereby determines whether a particular text-based character (among one or more possible particular text-based characters) is present in the text-based communication. At 420, the server identifies, in the text-based communication, the particular text-based character and a sequence of text-based characters associated with the particular text-based character. At 430, based on a mapping of the sequence of text-based characters to a particular meeting type, the server determines that the sequence of text-based characters corresponds to the particular meeting type. At 440, the server generates a meeting template of the particular meeting type.

Presented herein are techniques for automatically scheduling meetings based on text-based characters (e.g., hashtags). In one specific example, a server parses text and identifies a hashtag contained in various text-based or other user interfaces. The server makes an API call to a scheduling API in communication with the scheduling server. The scheduling server/API may generate, and forward to the server, a link with scheduling information. The server may generate a meeting template for the meeting.

These techniques may be utilized in various other forms, such as for voice interactions where the user interface is voice audio that is converted to text using voice recognition technologies, short-messaging system (SMS)/text communications, etc. Moreover, any flag/symbol/user-definable control character (e.g., asterisk, ampersand, percentage sign, etc.) may be used instead of/in addition to a hashtag to trigger automatic scheduling of appointments as described herein.

In one form, a computer-implemented method is provided. The method comprises: parsing a text-based communication for a particular text-based character; identifying, in the text-based communication, the particular text-based character and a sequence of text-based characters associated with the particular text-based character; based on a mapping of the sequence of text-based characters to a particular meeting type, determining that the sequence of text-based characters corresponds to the particular meeting type; and generating a meeting template of the particular meeting type.

The method may further comprise sending, to a scheduling server, a request to generate an appointment link that identifies the meeting template; receiving, from the scheduling server, the appointment link; and based on the appointment link, generating the meeting template. In one specific example, the appointment link includes an appended contact identifier, and the method still further comprises automatically populating contact data of the meeting template based on the appended contact identifier. The particular text-based character may be a hashtag, and the sequence of text-based characters may be an unbroken sequence of text-based characters following the hashtag. The text-based communication may include notes in a customer relationship management application, a message or post in online media, or an e-mail message.

In another form, an apparatus is provided. The apparatus comprises: one or more network interfaces configured to send and/or receive messages; and one or more processors coupled to the network interfaces, wherein the one or more processors are configured to: parse a text-based communication for a particular text-based character; identify, in the text-based communication, the particular text-based character and a sequence of text-based characters associated with the particular text-based character; based on a mapping of the sequence of text-based characters to a particular meeting type, determine that the sequence of text-based characters corresponds to the particular meeting type; and generate a meeting template of the particular meeting type.

In another form, one or more non-transitory computer readable storage media are provided. The non-transitory computer readable storage media are encoded with instructions that, when executed by a processor, cause the processor to: parse a text-based communication for a particular text-based character; identify, in the text-based communication, the particular text-based character and a sequence of text-based characters associated with the particular text-based character; based on a mapping of the sequence of text-based characters to a particular meeting type, determine that the sequence of text-based characters corresponds to the particular meeting type; and generate a meeting template of the particular meeting type.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
parsing a text-based communication for a particular text-based character;
identifying, in the text-based communication, the particular text-based character and a sequence of text-based characters associated with the particular text-based character;
based on a mapping of the sequence of text-based characters to a particular meeting type, determining that the sequence of text-based characters corresponds to the particular meeting type; and
generating a meeting template of the particular meeting type.

2. The method of claim 1, further comprising:
sending, to a scheduling server, a request to generate an appointment link that identifies the meeting template;
receiving, from the scheduling server, the appointment link; and
based on the appointment link, generating the meeting template.

3. The method of claim 2, wherein the appointment link includes an appended contact identifier, wherein the method further comprises:
automatically populating contact data of the meeting template based on the appended contact identifier.

4. The method of claim 1, wherein the particular text-based character is a hashtag, and the sequence of text-based characters is an unbroken sequence of text-based characters following the hashtag.

5. The method of claim 1, wherein the text-based communication includes notes in a customer relationship management application.

6. The method of claim 1, wherein the text-based communication includes a message or post in online media.

7. The method of claim 1, wherein the text-based communication includes an e-mail message.

8. An apparatus comprising:
one or more network interfaces configured to send and/or receive messages; and
one or more processors coupled to the network interfaces, wherein the one or more processors are configured to:
parse a text-based communication for a particular text-based character;
identify, in the text-based communication, the particular text-based character and a sequence of text-based characters associated with the particular text-based character;
based on a mapping of the sequence of text-based characters to a particular meeting type, determine that the sequence of text-based characters corresponds to the particular meeting type; and
generate a meeting template of the particular meeting type.

9. The apparatus of claim 8, wherein the one or more processors are further configured to:
send, to a scheduling server, a request to generate an appointment link that identifies the meeting template;
receive, from the scheduling server, the appointment link; and
based on the appointment link, generate the meeting template.

10. The apparatus of claim 9, wherein the appointment link includes an appended contact identifier, and wherein the one or more processors are further configured to:
automatically populate contact data of the meeting template based on the appended contact identifier.

11. The apparatus of claim 8, wherein the particular text-based character is a hashtag, and the sequence of text-based characters is an unbroken sequence of text-based characters following the hashtag.

12. The apparatus of claim 8, wherein the text-based communication includes notes in a customer relationship management application.

13. The apparatus of claim 8, wherein the text-based communication includes a message or post in online media.

14. The apparatus of claim 8, wherein the text-based communication includes an e-mail message.

15. One or more non-transitory computer readable storage media encoded with instructions that, when executed by a processor, cause the processor to:
parse a text-based communication for a particular text-based character;
identify, in the text-based communication, the particular text-based character and a sequence of text-based characters associated with the particular text-based character;
based on a mapping of the sequence of text-based characters to a particular meeting type, determine that the sequence of text-based characters corresponds to the particular meeting type; and
generate a meeting template of the particular meeting type.

16. The non-transitory computer readable storage media of claim 15, wherein the instructions further cause the processor to:
send, to a scheduling server, a request to generate an appointment link that identifies the meeting template;
receive, from the scheduling server, the appointment link; and
based on the appointment link, generate the meeting template.

17. The non-transitory computer readable storage media of claim 16, wherein the appointment link includes an appended contact identifier, and wherein the instructions further cause the processor to:
automatically populate contact data of the meeting template based on the appended contact identifier.

18. The non-transitory computer readable storage media of claim 15, wherein the particular text-based character is a hashtag, and the sequence of text-based characters is an unbroken sequence of text-based characters following the hashtag.

19. The non-transitory computer readable storage media of claim 15, wherein the text-based communication includes notes in a customer relationship management application.

20. The non-transitory computer readable storage media of claim 15, wherein the text-based communication includes a message or post in online media, or an e-mail message.
